(19) United States
(12) Patent Application Publication
(10) Pub. No.: US 2002/0039069 A1
(43) Pub. Date: Apr. 4, 2002

(54) System and method for remote monitoring of cathodic protection systems

(76) Inventors: Randall H. Chance, Round Rock, TX (US); David X. Young, Austin, TX (US); Donald J. Davis, Austin, TX (US); Thomas A. Garner, Austin, TX (US); Michael A. Young, Pflugerville, TX (US); Michael P. Devine, Austin, TX (US); Spencer Nimberger, Houston, TX (US); Kevin J. Cessac, Houston, TX (US); Richard J. Smalling, Austin, TX (US); Kejun Chen, Austin, TX (US)

Correspondence Address: WILSON SONSINI GOODRICH & ROSATI, 650 PAGE MILL ROAD, PALO ALTO, CA, 943041050

(21) Appl. No.: 09/897,700

(22) Filed: Jun. 29, 2001

Related U.S. Application Data
(63) Continuation-in-part of application No. 09/897,701, filed on Jun. 29, 2001.
Application No. 09/897,701 is a continuation-in-part of application No. 09/427,415, filed on Oct. 27, 1999.

(51) Int. Cl. G08C 19/10

(52) U.S. Cl. 340/870.09; 340/870.11

(57) ABSTRACT

A system and method for remote monitoring of a cathodic protection system are disclosed. In one embodiment of a system incorporating teachings of the present disclosure, a remote telemetry device may be communicatively coupled to at least one cathodic protection device operable to provide direct current to a metallic object, the telemetry device may be programmable to communicate with a central station, and the telemetry device may incorporate a transmitter and a processor. The processor may include memory and programming code to control operation of the telemetry device, and the transmitter may be operable to communicate information to a central station.

### RELATIONSHIP TO CO-PENDING APPLICATIONS

This application is a continuation-in-part of U.S. application Ser. No. 09/427,415, filed on Oct. 27, 1999, which is incorporated herein by reference in its entirety.

### FIELD OF THE INVENTION

The present disclosure relates in general to the field of information gathering, and more particularly to a system and method for remote monitoring of cathodic protection systems.

### BACKGROUND OF THE INVENTION

Cathodic protection often involves the application of a direct electrical current to an object to inhibit the corrosion of that object. Typical applications for cathodic protection systems include metallic pipelines, offshore platforms, and situations where a metallic material is subjected to a corrosive environment. Though the direct current of a typical cathodic protection system may be applied using various techniques, one common technique is to make use of a series of rectifiers distributed along the surface of the object to be protected. Such a system is commonly referred to as a distributed cathodic corrosion protection system.

In operation, an individual rectifier of a distributed cathodic corrosion protection system provides current to a specific section of the object to be protected. Because the system may be distributed across a large and remote area, it is often difficult and occasionally dangerous to monitor the overall system's performance. Each rectifier location may need to be checked individually, and such checks can prove very costly and time consuming.

Conventionally, the periodic monitoring and checking of the output characteristics and the performance of the individual rectifiers was done manually by sending a person to the location of each rectifier and taking direct readings. The manual checking technique is often cost prohibitive and potentially dangerous. Other techniques involve the use of low-level communication satellites that forward information received from a remote pipeline rectifier monitoring unit to a data collector, as described in U.S. Pat. No. 5,785,842, issued to Speck. The Speck solution has several significant drawbacks. Its operation requires costly low orbit satellites that have a limited life expectancy.

As such, there remains a need for a lower cost and more reliable communication system for use with a distributive cathodic corrosion protection system.

### SUMMARY

In accordance with one aspect of the present disclosure, a system for monitoring a cathodic protection system may include a remote telemetry device, which may be communicatively coupled to at least one cathodic protection device operable to provide direct current to a metallic object. The telemetry device may be programmable to communicate with a central station, and the telemetry device may incorporate a transmitter and a processor. The processor may include memory and programming code to control operation of the telemetry device, and the transmitter may be operable to communicate information to a central station.

In a further embodiment, a system incorporating teachings of the present disclosure may include a remote telemetry device to monitor at least one element of a distributed cathodic protection system, a central station responsive to the remote telemetry device, a central database to store and organize information communicated by the telemetry device, and a computer network user interface that provides a user with remote access to the information stored at the central database. The telemetry device may be programmable to communicate with a central station upon at least one of an alarm condition, a user request, receipt of a signal from the central station, and a regular time interval.

The occurrence of an alarm condition may be determined by settings in the device that may be configured by the user. Allowing the user to configure these settings, either via a configuration tool or remotely through a web user interface, means the same device may be used in a variety of applications by a variety of users.

Likewise, the time interval may be user programmable either remotely or through the configuration tool. The user may also establish a schedule within either the telemetry device or on the web site to prompt “on-demand” collection of data. The central station may include a central station computer server and software embedded therein to provide connection with a wide area network communications module, a database hosting module hosting a central database, and a notification module to issue alarm notification messages.

A particular embodiment as disclosed provides a telemetry system that is unique in its simplicity, scalability, usability and applicability. In a particular illustrative embodiment, the system combines the Internet, relational databases, programming, existing networks and automated notification schemes in a way that allows a wide variety of customers to automate a wide variety of applications using the same system at very low cost and with minimal changes to long standing business practices.

There may be a variety of different applications that use distributed cathodic protection and would benefit from telemetry. As an example of the breadth of applications where telemetry can impact a business employing cathodic protection systems, large oil and gas concerns may wish to monitor natural gas pipelines, storage tanks, and offshore platform components and systems.

In one embodiment, the present system provides a variety of telemetry devices that use a variety of communication networks, all tied to a central host computer that is operated by the customer using a single Internet access point. The family of telemetry devices may offer input ranges that can interface to many applications where telemetry and cathodic protection systems may be used. The use of a standardized solution for such a variety of applications makes it cheaper and easier to install and maintain the system. Spare parts are common across applications and platforms and the telemetry devices themselves can be easily moved among remote sites as needed.

A system incorporating teachings of the present disclosure may also include an automated notification process that is reprogrammable by the customer using the Internet. This process may also be shared among applications within a customer. By standardizing on this system for a variety of applications the customer may better utilize field based maintenance personnel across a variety of applications within the same geographical territory. Because it is cost effective and easy to use, such a system may open up many markets for telemetry and cathodic protection systems that could not be justified from an economics viewpoint with traditional systems.

The use of a single system for a variety of applications reduces the total cost of purchasing, operating and maintaining the system. Such a system also allows the overhead, network center, Internet interface and notification processes to be leveraged over a greater number of devices thereby lowering overall costs.

### BRIEF DESCRIPTION OF THE DRAWINGS

A more complete understanding of the present embodiments may be acquired by referring to the following description taken in conjunction with the accompanying drawings, in which like reference numbers indicate like features, and wherein:

FIGS. 1A-1D depict components of an embodiment of a system for remotely reading a bank of utility meters;

FIG. 2 depicts an embodiment of a remote collector, which may be a component of a system for remotely reading utility meters;

FIG. 3 depicts an internal view of an embodiment of a housing with a remote collector and a transmission device placed within a housing;

FIG. 4 shows an embodiment of a transmission device mounted within a housing;

FIG. 5 shows a flow diagram depicting an embodiment of a method for remotely reading utility meters on a pre-set or regular basis; and

FIG. 6 shows a flow diagram depicting an embodiment of a method for remotely reading utility meters on a special or off-cycle basis.

FIG. 7 shows a general block diagram a system with a telemetry unit.

FIG. 8 is a general diagram that illustrates certain functionality of the telemetry system.

FIG. 9 is a block diagram that illustrates further details of the telemetry unit.

FIG. 10 depicts a block diagram of a distributed cathodic protection system incorporating teachings of the present disclosure.

### DETAILED DESCRIPTION OF THE DRAWINGS

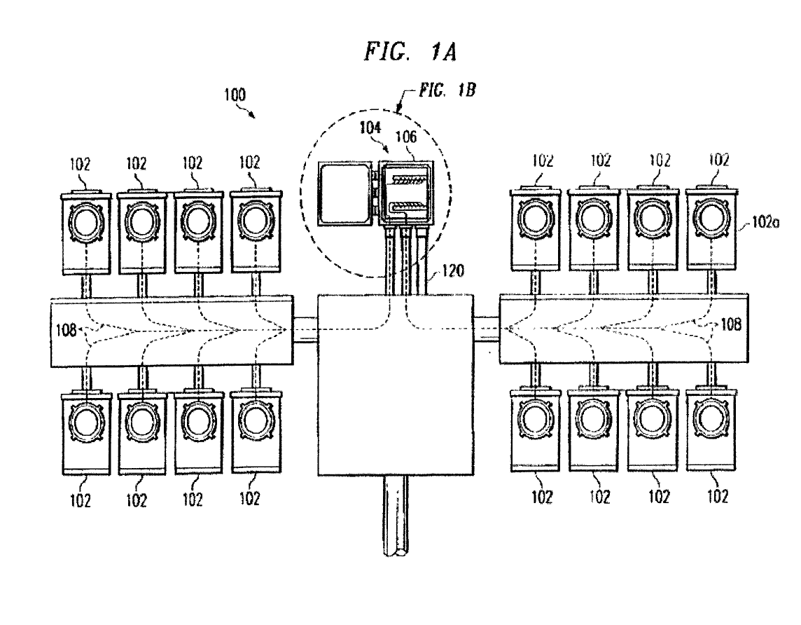

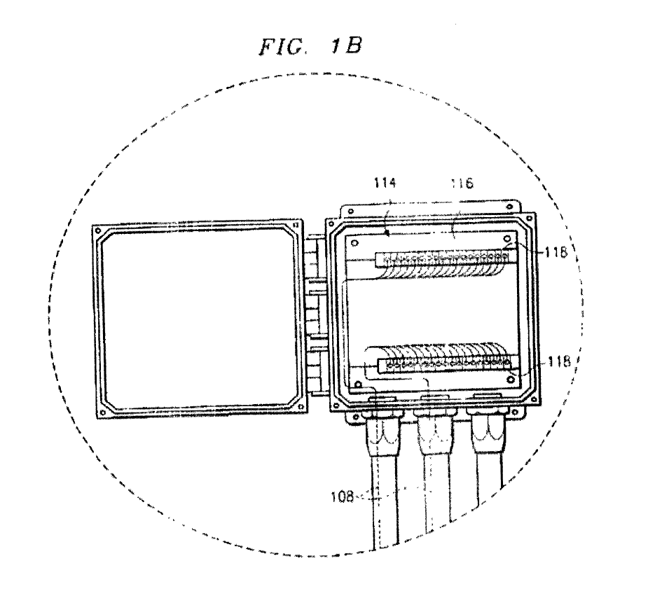

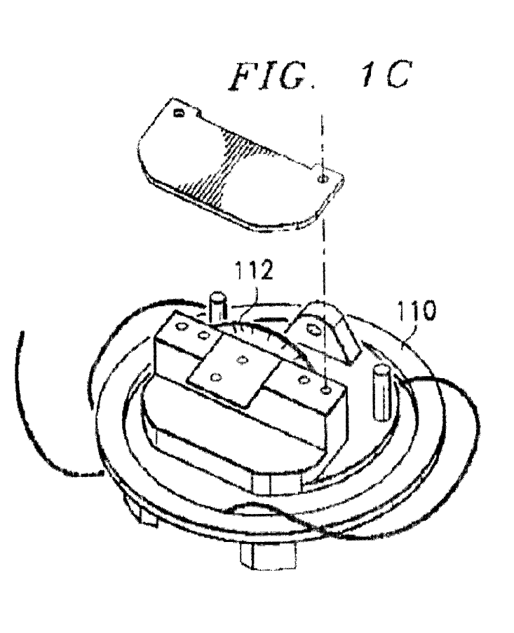

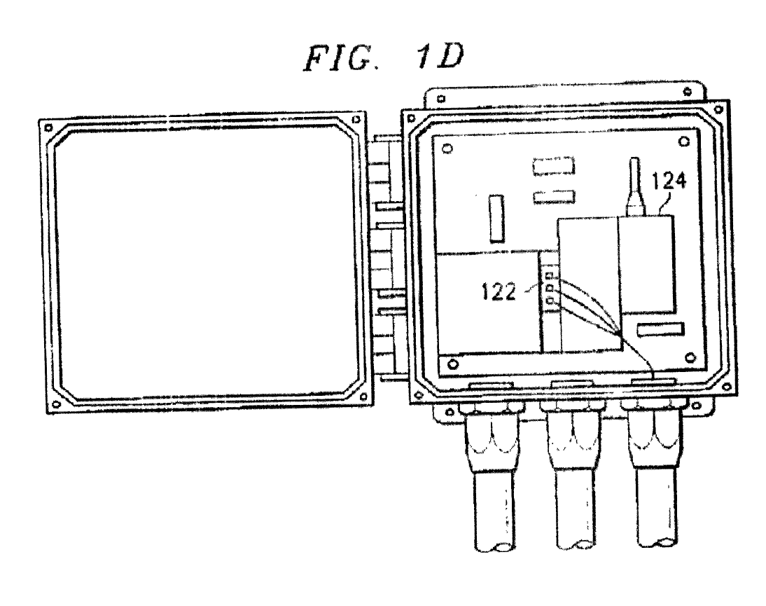

FIG. 1A depicts an embodiment of a system representatively depicted at 100 for remotely reading a bank of utility meters. As depicted, system 100 may be located at a mounting wall of a multiple tenant facility, which may include any number of buildings. For illustrative purposes, the meter mounting wall includes a bank of sixteen utility meters 102. However, a system incorporating teachings of the present invention may incorporate any number of utility meters. Meters 102 may be connected to remote collector 104 by respective communication lines 108, which may be seen in FIG. 1B. Communication lines 108 may be made from any suitable type of communication line. For example, communication lines 108 may be three-wire KYZ dry contact closure communication lines. In some embodiments, communication lines 108 may include fiber optic cables.

Meters 102 may be utility meters and could be, for example, electric meters, gas meters, or water meters. Attached to the terminal ends of communication line 108 may be respective meter readers 110, depicted in FIG. 1C. Meter readers 110 may interface with meters 102 via an interface output such as a standard KYZ output or an Optical Pulse Initiator (OPI) manufactured by American Innovations. The interface output or OPI may make use of a wired connection to facilitate communication of data from the sensor to the telemetry device. The communication may also occur wirelessly across, for example, an unlicensed wireless data channel. Meter reader 110 may be installed in a respective meter 102 in order to count or track the utility usage and send a usage signal representing utility usage back to remote collector 114, shown in FIG. 1B, via communication line 108, which is also shown in FIG. 1B.

For exemplary purposes, in FIG. 1C, meter 102a is shown in an exploded and expanded view as having a utility usage tracking device 112. Utility usage tracking device 112 may be part of a utility meter and may provide a visual indication of how much of a utility such as electricity has been passed through meter 102a. In an electric meter, a rotating disk with a black marking on its surface may be used as a usage tracking device. By counting the number of times the black marking passes, indicating revolutions made by the disk, a counter may keep track of how much electricity has passed through the utility meter. Meter reader 110 of FIG. 1C may be installed inside meter 102a to monitor utility usage tracking device 112 and track how much of a utility is being used.

Each communication line 108 leaves a respective meter such as meter 102a and enters into housing 106, shown in FIG. 1A. Once inside housing 106, each communication line 108 may terminate at and connect to remote collector 114, shown in FIG. 1B. Remote collector 114 may include a terminal connector board 116, shown in FIG. 1B and screw terminal connectors 118, also shown in FIG. 1B. Communication lines 108 may enter through the bottom of housing 106 and attach to remote collector 114 via screw terminal connectors 118.

Located within housing 106 and behind remote collector 114 may be power supply input 122, shown in FIG. 1D, and transmission device 124, also shown in FIG. 1D. The elements within housing 106 may make up collector box 104 and may be powered with AC electricity supplied by AC power line 120 as shown in FIG. 1A. AC power line 120 may enter through the bottom of housing 106 and terminate at power supply input 122, shown in FIG. 1D. In some embodiments, externally supplied AC power may be replaced with other suitable power supplies. For example, some embodiments may be, at least occasionally powered by lithium batteries, other suitable batteries, or a solar/battery power combination.

As depicted in FIG. 1D, transmission device 124 may be a cellular radio such as the BULLHORN™ AMR6, APM4, or similar device employing technology owned by American Innovations of Austin, Texas. Transmission device 124 may be other types and brands of communication devices and may transmit utility usage data using cellular communication such as MICROBURST technology.

Aeris Corporation offers MICROBURST as a low cost alternative for sending small data packets of information over an existing cellular network. This technology may use digital control channels of existing cellular networks to send fifteen digit data packets. The control channel typically has less traffic and higher power than the voice channels and allows for more robust operation. In fact, MICROBURST may be available in areas where cellular voice service may not be available.

MICROBURST transmissions tend to be cost-effective because the data packets are sent over an established cellular telephone infrastructure and the signaling and messaging operate anywhere Advanced Mobile Phone Service (AMPS) is available. Because the control channels and not the voice channels of the cellular network are employed, MICROBURST transmissions generally operate within and transparent to an existing cellular infrastructure. Because of this transparent operation within an established network, expensive initial outlays or expensive upgrades may not be necessary to utilize the technology. As such, control channel cellular communications may be less expensive than other forms of cellular communication.

In operation, control channel cellular communications may transmit data packets of information within the control channels of a cellular network using standard IS-41 signaling mechanisms and standard message protocols according to EIA/TIA-553 specifications. Typically, the signals may be sent and received with a single device. The Reverse Control Channel (RECC) may be used when sending data from the device, such as transmission device 124, and the Forward Control Channel (FOCC) may be used when sending data requests from a host control channel to a transmission device.

Meter reader 110, installed within each meter 102, may observe utility usage and pass usage signals via communications lines 108 to remote collector 114. In one embodiment, meter reader 110 could be designed without data storage capacity making it unable to store utility usage data. In this embodiment, meter reader 110 would merely monitor utility usage tracking device 112. Every time meter 102 recognizes a certain utility usage milestone, such as a complete revolution of utility usage tracking device 112, meter reader 110 would send a signal through communication lines 108 to remote collector 114. In this way, meter reader 110 may communicate the milestone and thereby allow remote controller 114 to convert the utility usage milestone into stored utility usage data. Communicatively coupled to remote collector 114 may be transmission device 124, which may occasionally access the utility usage data stored in remote collector 114 on a selected periodic cycle or as required on an off cycle basis and communicate the stored utility usage via cellular communication.

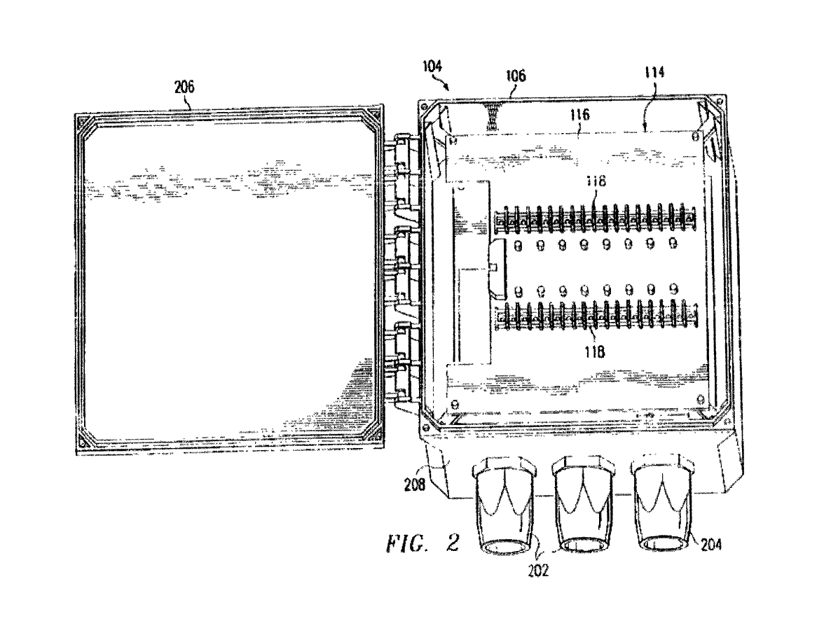

FIG. 2 depicts a detailed representation of remote collector 114. As depicted in FIG. 2, remote collector 114 may be enclosed in housing 106 and may include a terminal connector board 116 and screw terminal connectors 118. Housing 106 may be a single enclosure and be NEMA 4, weatherproof, and tamper resistant. The tamper resistance characteristic may be very important, because housing 106 encloses components that may be responsible for utility readings used to calculate a customer's bill. Housing 106 may include door 206 attached to housing 106 by hinges or other suitable means. Housing 106 may be designed to mount externally on a wall or conduit near a bank of meters 102 in order to enable remote collector 114 to store utility usage data from a number of meters.

Attached to underside 208 of housing 106 may be three inputs for communication lines or power supply lines. There may be two communication line inputs 202 and one power input 204 or any other suitable combination.

Communication lines 108 may enter into housing 106 via communication inputs 202 and continue on and connect to terminal connector board 116 using screw terminal connectors 118. Terminal connector board 116 may have at least as many screw terminal connectors 118 as are needed to interface with the number of meters in the meter bank.

For example, FIG. 2 shows a terminal connector board 116 with two rows of screw terminal connectors 118 able to support up to sixteen different utility meters. Screw terminal connectors 118 support inputs from OPI or other utility meter KYZ output including Form A contact closures, pulse outputs from water meters, or any other suitable type of output.

In a particular embodiment, remote collector 114 will not require inputs into all screw terminal connectors 118 or require inputs to specific screw terminal connectors 118 in order to operate.

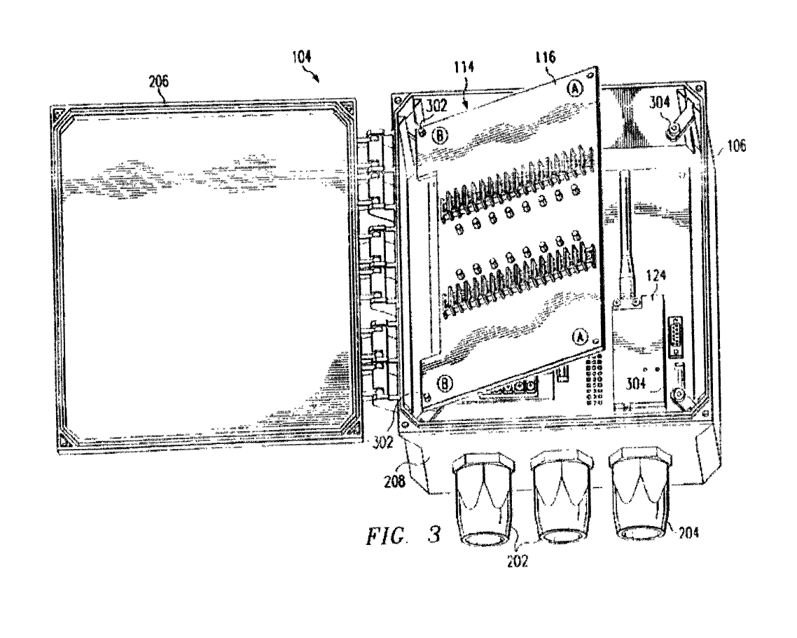

FIG. 3 depicts an expanded view of housing 106 illustrating how the remote collector 114 and transmission device 124 may be placed within housing 106. Terminal connector board 116 of remote collector 114 may be mounted near the front of housing 106 on hinge supports 302 and supports 304. By mounting terminal connector board 116 on hinge supports 302 and supports 304, there may be room in the rear portion of housing 106 for such components as transmission device 124. Terminal connector board 116 may be operable to rotate from zero to ninety degrees in order to allow access to the components mounted behind terminal connector board 116. Hinge supports 302 may connect remote collector 114 to housing 106 and allow for ninety-degree rotation of terminal connector board 116, which may reveal transmission device 124 below.

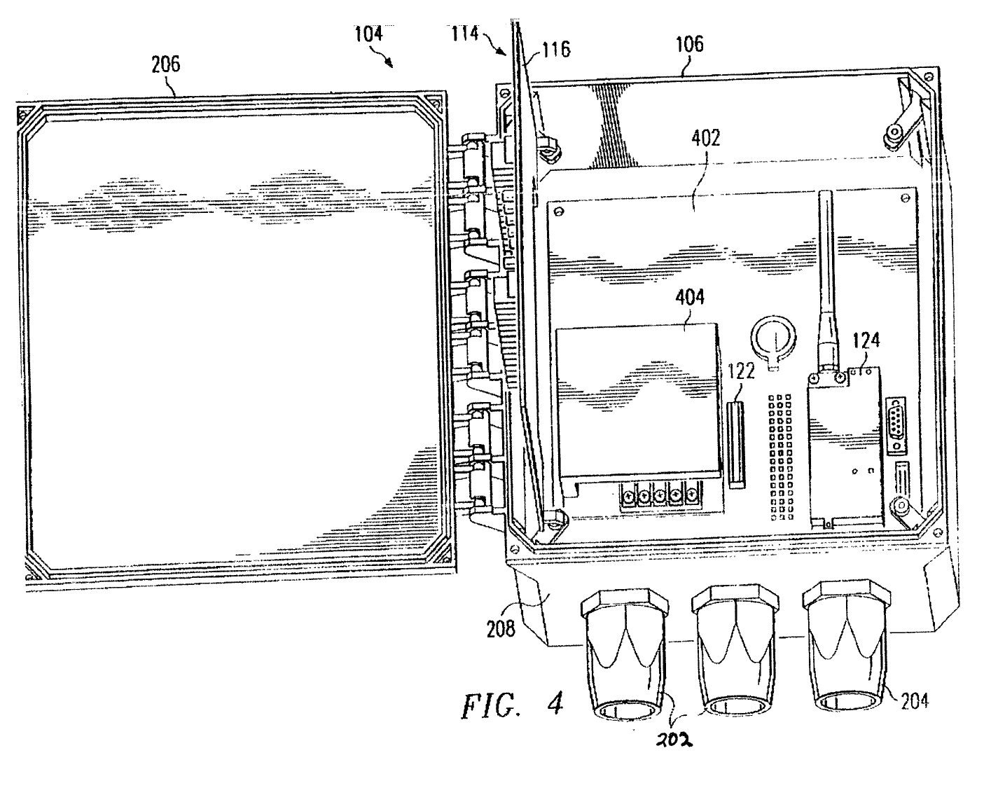

FIG. 4 shows transmission device 124 mounted within housing 106. Terminal connector board 116, now in an open or ninety-degree position, allows access to components behind remote collector 114. Mounted against controller board 402 may be an additional power supply 404, power supply input 122, and transmission device 124. Power supply line 120 (not shown in FIG. 4) may enter housing 106 through power input 204 and may connect to power supply input 122. In one embodiment, power supply input 122 can allow for collector box 104 to be powered by externally supplied AC power via power supply line 120.

Transmission device 124, which may be essentially a radio device suitable for wireless communication, may be communicatively coupled to remote collector 114 and operable to transmit utility usage data to a database. Transmission device 124 may use Aeris, cellemetry, cellular phone networks, or other communication channels.

Meter reader 110 (shown in FIG. 1C) may be equipped with a sensor operable to provide a usage signal (e.g., a pulse) to remote collector 114. Remote Collector 114 may then convert the signal into utility usage data and store that utility usage data. In some embodiments, data other than utility usage data may be collected by Remote Collector 114. Transmission device 124 may be designed to access the stored utility usage data and to transmit it in up to six digits of index resolution. For cost-effective monitoring of meters and to conserve battery power if battery power is the power source of choice, transmission device 124 may be powered on only during the short transmission period.

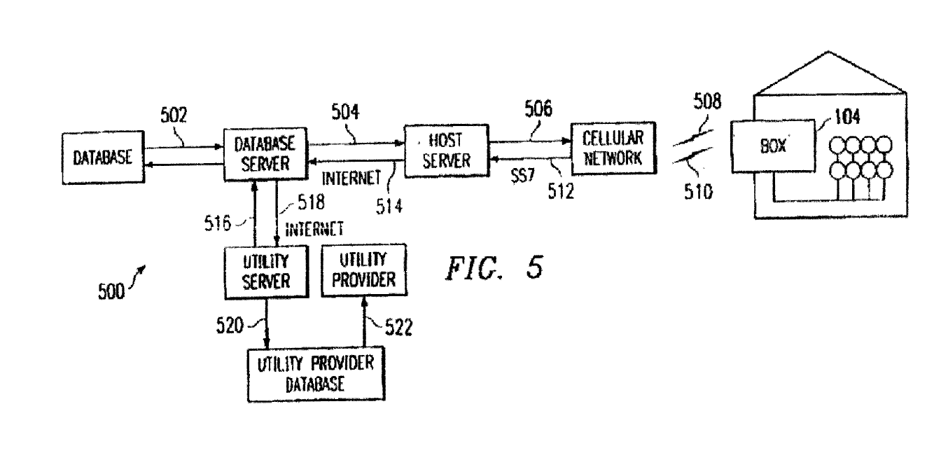

FIG. 5 shows a flow diagram depicting system 500 and associated method for remotely reading utility meters on a pre-set or regular basis. At step 502, a database may automatically query a database server and requests a monthly meter read for all the meters connected to a collector box (e.g., collector box 104). This request may be based on a pre-set reporting cycle. This pre-set cycle may be daily, weekly, monthly, yearly, or any other regular basis as desired by the utility provider. In one embodiment, the utility provider to whom the meters belong may freely arrange and/or change the pre-set reporting cycle. In a particular embodiment, the utility provider may be able to access a database server, the database, and the pre-set schedule using a secure TCP/IP connection over the Internet. In step 504, the database server forwards the request from the database to a host server using, for example, a secure TCP/IP connection over the Internet.

The request may prompt the host server to page the primary mobile identification number (MIN) for a given collector box's (e.g., collector box 104) transmission device (e.g., transmission device 124). In a particular embodiment, the transmission device may have at least one unique MIN with a Number Plan Area (NPA) field set to 175. By using an NPA of 175, the transmission may be recognizable by the Signaling System 7 (SS7) network as a transmission that should avoid voice cellular frequencies. Typically, an NPA of 175 cannot be used by traditional voice calls. After the host server receives the request, in step 506, the host server may forward the request via the SS7 network. The host server may access a roamer port set up on a switch and provide it with the proper MIN for a given transmission device. This may allow the switch to send a cellular page to the transmission device and trigger the transmission device to transmit the requested utility usage data.

When transmitted over the cellular network, the page may be received at step 508 by a collector box (e.g., collector box 104 of FIG. 1). After receiving the request, the transmission device within the collector box may begin to respond to the request by transmitting, at step 510, stored utility usage data in a series of data packets. The data packets may contain utility usage data for one or more meters per transmission. In one embodiment, the data packets may consist of two five digit meter reads, a meter port location, and a type indicator. The type indicator indicates whether the meter read is a pre-set cycle read, a special and off-cycle read, a test read, or a demand peak read. The data packet can be a sixteen digit array with the first digit being an “*” followed by the port location N, a five digit meter reading for part location N, a two digit reserved space, a five digit meter reading for port location N+1, a read indicator type, and one final digit reserved for future use. Other packet configurations may be used. For example, each packet may allow for reading as many as eight or more meters.

In step 512, the data packets may be received by the cellular network and forwarded over the SS7 network to the host server. When the data packets are received at the host server, the MIN, a meter identifier (e.g., the meter's Electronic Serial Number (ESN)), and utility usage data are extracted from the data packet. The host server may then determine the destination of the data. In step 514, the host server may forward the data extracts using a secure TCP/IP connection over the Internet to the database server. At step 516, the database server may then format the data extracts and store the formatted data extracts in the database.

The data extracts might at step 518 be transmitted to the utility server via electronic mail or the Internet. The data may also, at step 520, be stored in a utility provider database where it can be easily accessed by the utility provider in step 522.

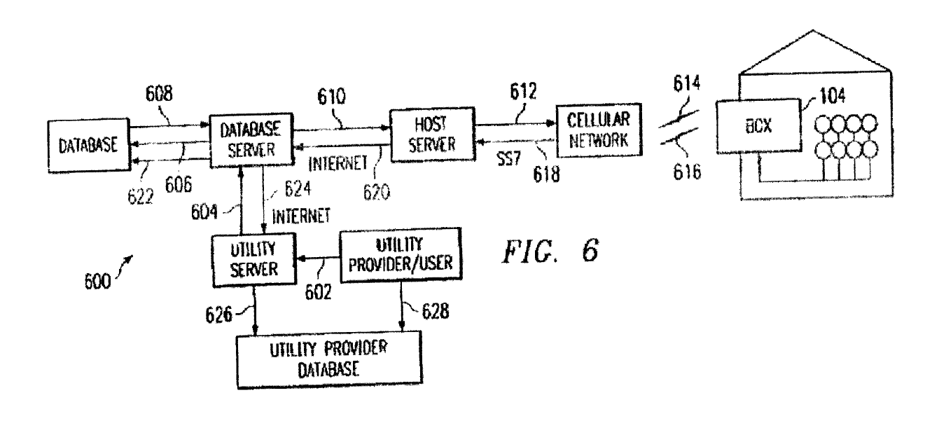

FIG. 6 shows a flow diagram depicting system 600 and an associated method for remotely reading utility meters on a special or off-cycle basis as desired by the utility provider. System 600 differs from system 500 in that system 600 may be employed when requesting utility usage data in special off-cycle circumstances, for example, in instances where a party moves in or moves out of a property after the pre-set cycle readings have been transmitted.

In step 602, a utility provider or user may request a special off-cycle reading of a meter. At step 604, a utility server may send a request to a database server via electronic mail or a secure TCP/IP connection over the Internet. At step 606, the database server may query a database to determine the correct MIN for the collector box connected to the meter to be read. The database, at step 608, may forward the correct MIN to the database server and the database server may send, at step 610 the request to a host server over a secure TCP/IP connection on the Internet. After the host server receives the request, in step 612, the method of 600 may closely track method 500 of FIG. 5.

A page may be sent via a cellular network and received at step 614 by a collector box (e.g., collector box 104 of FIG. 1). After receiving the request, a transmission device within the collector box may begin to respond to the request by transmitting, at step 616, stored utility usage data in a series of data packets. In step 618, the data packets may be received by the cellular network and forwarded over the SS7 network to the host server. When the data packets are received at the host server, the MIN, a meter identifier (e.g., the meter's Electronic Serial Number (ESN)), and utility usage data may be extracted from the data packet. The host server may also determine the destination of the data. In step 620, the host server may forward the data extracts using a secure TCP/IP connection over the Internet to the database server. At step 622, the database server may format the data extracts and store the formatted data extracts in the database.

The data extracts may also at step 624 be transmitted to the utility server via electronic mail or the Internet. The data may also, at step 626, be stored in a utility provider database where it can be easily accessed by the requesting utility provider or user in step 628.

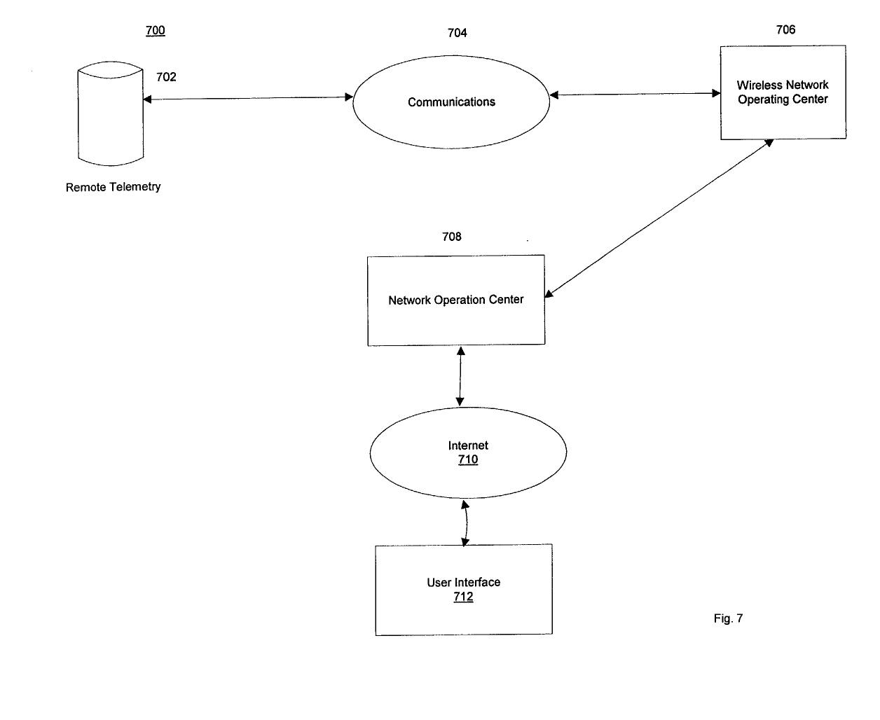

Referring to FIG. 7, a telemetry system 700 is disclosed. The telemetry system 700 includes a remote telemetry unit 702, a communications network 704, a wireless network operating center (NOC) 706, and a monitoring network operating center (NOC) 708. The remote telemetry unit 702 may take measurements and retrieve data from one or more different external devices. The remote telemetry unit 702 is in two way communications with the communications networks 704 and the wireless network operating center 706. The remote telemetry unit 702 may transmit measured data through the communications networks 704 and 706 to the monitoring network operating center 708. The retrieved information may be based on a periodic or programmed scheduled measurement, or may be in response to a page request originating from the monitoring network operating center 708.

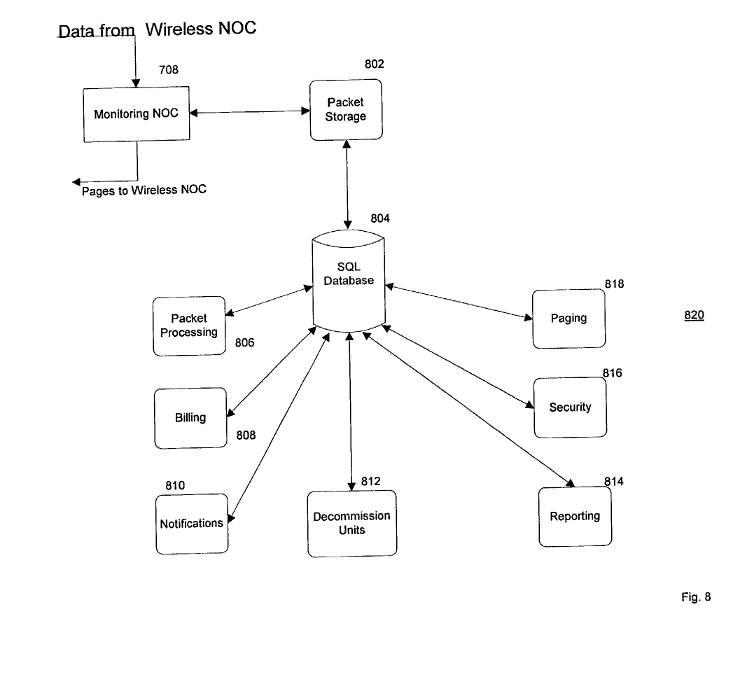

Referring to FIG. 8, the monitoring network operating center 708 is coupled to a database and software system 800. The network operating center 708 receives data from the wireless network operating center 706 and sends pages to the wireless network operating center 706. Data from the monitoring network operating center 708, such as packet data, may be transmitted to packet storage module 802 and then stored in database 804. In one embodiment, the database is an SQL database type. The database selects and uses one of a variety of processes to accept, decode, calculate and store the data received from the WAN communications server. The database 804 is accessible to a variety of functional modules. These functional modules include packet processing unit 806, billing system 808, notifications module 810, decommission units 812, reporting module 814, security module 816, and paging module 818. Each of the functional modules may retrieve data, modify data, and store data with respect to the database 804. In some embodiments, there may also be a Shipping/Testing module that allows users to view order, shipment, and test information through the same user interface that is used to access the data collected from the telemetry devices and change configuration parameters.

By linking manufacturing processes into the SQL database, the customer may see the status of the telemetry units ordered, shipped, installed or returned. With regard to the SQL database, it may be any of several relational database package such as those offered by Oracle, Microsoft, Sybase and the like but is preferably Microsoft SQL Server 2000 or Microsoft's SQL Server version 7.0. The functional modules may also be implemented by a variety of software routines that execute on a computer system. For example, the Notifications module may employ any mail server but preferably Microsoft Exchange 2000 Server for electronic mail, facsimile and alphanumeric pages and Pagemaster Version 2.3 for numeric pages. In addition, various programming tools may be employed like Visual Basic, Visual C++ and Visual Interdev to code the processes, and the hardware may include virtually any server, with preference given to one that is Windows compatible.

In operation, packet processing module 806 provides for packets to be identified and decoded depending on the model type of the remote telemetry unit. Each model type is capable of collecting and reporting different sets of data, so the model type data is identified by differences in the packets. The raw data retrieved from the remote unit 702 is processed and turned into retrievable information. The database 804 is updated with the retrievable information. Based on completion codes of the packet data, other processes may be triggered. An example of other processes include billing, notification, or paging. The billing module 808 provides for charging customers based on a number of items, such as the number of packets transmitted, notifications, or alerts provided to the customer. The billing is based on monitored data from the telemetry unit, service plan changes, special reporting, specific extracts of data and other additional services. As particular services or events occur a billing account is updated and a charge is entered. At the end of each month, a bill may be automatically prepared and then sent to the customer for all such charges in addition to details associated with events relating to such billing.

The notification function 810 offers a variety of methods to notify or send data, alarms, or normal events. Such methods include e-mails, fax, electronic page, or numeric page. Notifications are set up via a web site directed by the customer, using a rules based criteria. In addition, the system offers customer defined reports or extracts of their data in a variety of available formats, such as e-mail, fax, electronic page, numeric page or file transfer protocol (FTP), with respect to such data.

The paging module 818 may be used to send pages to the remote telemetry unit 702 to request on-demand type data, to control particular outputs of such telemetry units, or to respond to configuration packets to notify the telemetry unit 702 that there is a complete path to the database 804. While the paging module 818 provides initiation of a paging request, the function of transmitting a paging signal to the telemetry unit 702 is handled by the wireless network operating center 706. In a particular embodiment, the wireless network operating center 706 is an Aeris type system.

The security function 816 provides a process that allows a customer to select particular users that may be able to view or modify particular parameters, reports, and schedules. Security can be set at multiple levels to restrict or allow access to more than sixty different feature sets. Security can also be set up at a user, user group, or global user group level, and/or at a unit, unit group level, or global unit group level.

The decommission units 812 provide for old units or units that have been returned or that are no longer in service to be decommissioned. This process allows individual components of the remote unit 702, a radio and/or the printed circuit board found within the remote unit 702, to be placed back into inventory for reuse. During such process a message is sent to the wireless network operating center 706 to inform the network operating center 706 that particular units have been deactivated.

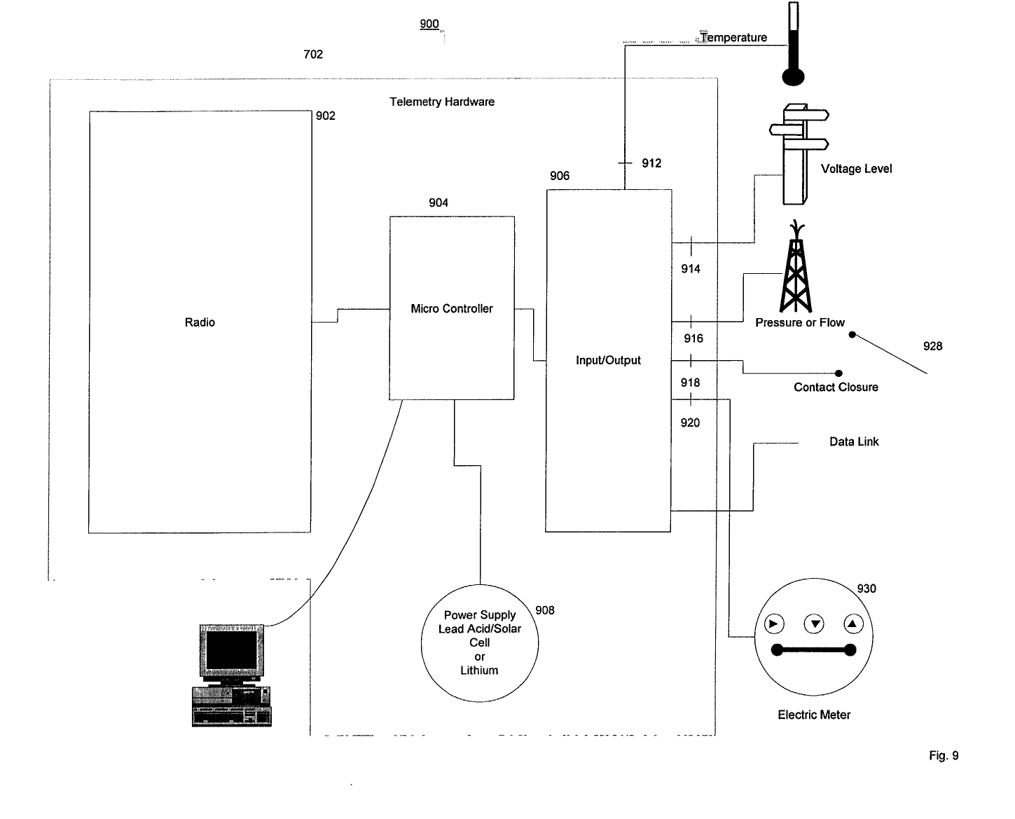

Referring to FIG. 9, a system 900 that utilizes remote telemetry unit 702 is disclosed. The remote telemetry unit 702 includes a radio module 902, a microcontroller 904, an input/output unit 906 and a power supply 908. The input/output module 906 provides a plurality of different input/output connections. Such input/output connections include temperature connection 912, voltage connection 914, pressure or flow connection 916, contact measurement connection 918, and electric meter connection 920. These input/output connections are adapted to measure data and take measurement readings of a variety of different external units. For example temperature connection 912 may take a temperature reading and voltage level connection 914 may read a voltage level of an external device, such as a rectifier connected to a pipeline. Pressure connection 916 may read a water or gas pressure from an external unit 926. Contact closure 928 may be measured with contact measurement connection 918 and an electric meter, such as meter 930, may be read by using input/output connection 920. The remote telemetry hardware unit 702 is programmable via software, such as a configuration software tool 910, loaded onto a personal computer. The configuration software tool 910 may download data, parameters, and settings into microcontroller 904 and thereby allow programming of the telemetry unit 702.

During operation, radio unit 902 may receive or transmit data collected through measurements performed and communicated via input/output module 906. The microcontroller 904 coordinates measurement reading activities and controls data transmission and communication of the radio unit 902. The microcontroller 904 and radio 902 are powered by the power supply 908, which may be a lead acid/solar cell or lithium type battery in certain embodiments.

The system 900 provides for either scheduled or on-demand measurements for a variety of different external devices. An advantage of this system 900, is that various types of different devices may be measured using a single flexible and programmable telemetry hardware unit 702. By using a generic and programmable remote telemetry unit 702, a utility or other user may read data from multiple units in the field at a low cost and with a single platform.

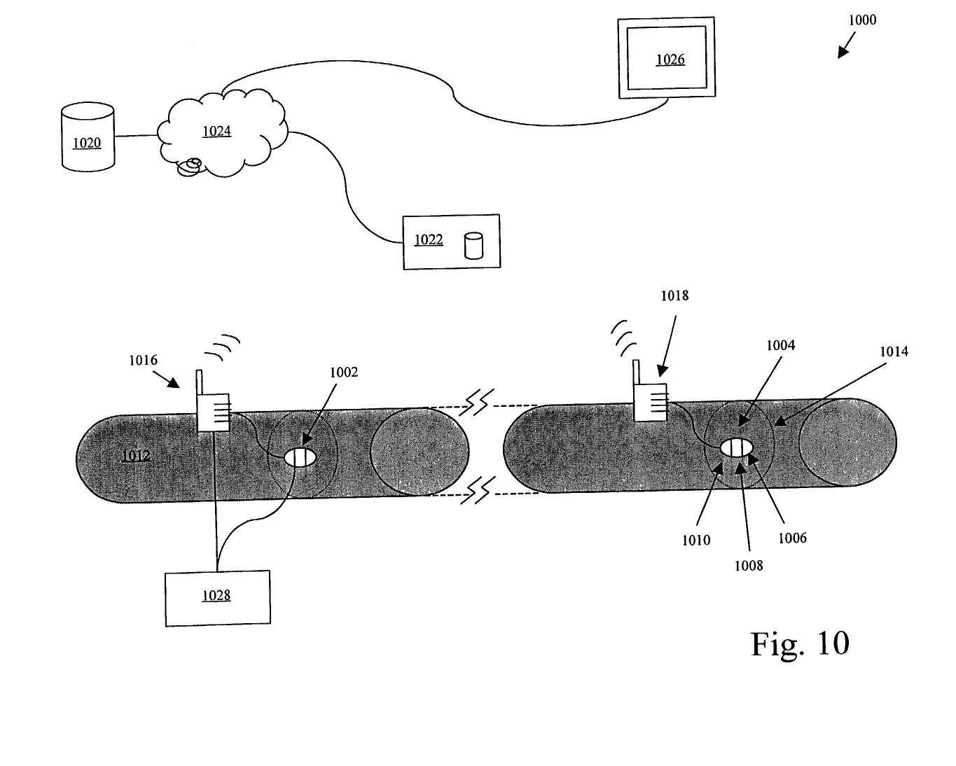

FIG. 10 depicts a block diagram of a distributed cathodic protection system 1000 incorporating teachings of the present disclosure. As depicted, system 1000 includes two cathodic protection devices 1002, 1004 that may include three elements, a measuring and interface device (MI device) 1006, a processor 1008, and a telemetry interface 1010. MI device 1006 may include a rectifier or some other electrical device, circuit, or system, capable of providing direct current to a metallic object in a corrosive environment. As depicted in FIG. 10, the object to be protected may be a pipeline 1012 transporting a corrosive substance. In operation, MI device 1006 may receive commercially available alternating electrical current and supply low-level direct electrical current to a section 1014 of a pipeline 1012.

The operating parameters and measurements of MI device 1006 may be processed by processor 1008, which may also include a memory for caching information. The information may also be passed along to telemetry interface 1010, which allows for the information to be communicated to a telemetry device 1016, 1018, similar to the devices described in FIG. 2. Telemetry device 1016, 1018 may include a transceiver that directly or indirectly communicates the information obtained by the cathodic protection devices 1002, 1004 to a central database 1020 to store and organize the information. In one embodiment, the transceiver of telemetry device 1016, 1018 may communicate the information to one or more median communication devices 1022 that have a local memory and processor.

Using median communication device 1022 may allow remote monitoring of a cathodic protection system in an area that does not have complete cellular coverage. For example, if telemetry devices 1016, 1018 are outside of a wide area wireless network (e.g., a cellular telephone network), a system incorporating teachings of the present disclosure may effectively use median communication device 1022 as a gateway device. As such, median communication device 1022 may: (1) be part of a local area wireless network with telemetry devices 1016, 1018; and, (2) be part of a wide area wireless network that facilitates communication of information from median communication device 1022 to a distributed computer network 1024, such as the Internet.

Communicatively coupled with distributed computer network 1024 may be central database 1020. In a preferred embodiment, a user may enjoy remote access to information stored at central database 1020. For example, a user may have a computing device 1026 that executes code to present the user with a user interface, which may be a browser, and the user may access central database 1020 via computer network 1024.

The system depicted in FIG. 10 may include a telemetry device with six inputs. Four of the inputs may be set to analog or digital. The analog inputs may be set to monitor from 0 to 50-milli-Volts to check the level of cathodic protection. In addition, there may be a rectifier interface, which may be part of the cathodic protection device, between the protection device and the telemetry device for signal conditioning and surge protection. The use of a separate back end rectifier interface may allow a relatively inexpensive telemetry device to work with a cathodic protection system.

There may also be additional analog or digital inputs that may allow, for example, an electricity meter at the rectifier location to be monitored (read) remotely using the same system. For example, in FIG. 10 an electrical power source 1028 may be powering both telemetry device 1016 and cathodic protection device 1002. If telemetry device 1016 dedicates four inputs to receive from cathodic protection device 1002 information relating to the then-current levels of cathodic protection, a separate input may be used to track the amount of electricity supplied by power source 1028. As such, telemetry device 1016 may monitor more than just cathodic protection levels.

The particular embodiments of the system disclosed have many benefits. For example, the disclosed system provides an end-to-end system that combines telemetry devices, communications, data warehousing, processing, grouping, presentation, automated notifications and date export. This system can be applied in a wide variety of applications and markets. It addresses the need for diverse communication technologies resulting from the relationship of RF coverage to population density (e.g., rural areas may use wired telephone networks due to very low population density, whereas urban areas are more likely to use wireless networks).

Further, the structure of the central station, Internet application and notification schemes supports multiple groups of users in such a way as to make it easy for value added resellers of system and services, thereby further supporting the use of the system across a broad range of applications.

The structure of the central station, Internet application and notification schemes are also designed to allow the user to route information where it needs to go depending on the situation. It also means that users see only the information they deem critical and do not have to sift through piles of data.

The use of a variety of communications networks makes the system less prone to obsolescence, and the open design of the system allows for the family of telemetry devices to be used by third party providers of data gathering and analysis services.

The use of multiple sensors and multiple input-output connections allows the device to be used with a vast variety of commercially available, non-proprietary sensors. It also allows for personnel with little training or understanding of the system being monitored, or the system doing the monitoring, to effectively install the telemetry device.

Another benefit with the disclosed system is that the customer is not required to know any details about the network employed—the customer hooks up the telemetry device to the sensor(s) and pays a single service bill without having to worry about the particular communications network employed. Selection of the proper network for each application and each remote site is done by choosing a telemetry device from the family of devices that accepts the proper style of input and transmits the requisite data in the particular coverage area for the lowest rate.

The unique data gathering and reporting methodology substantially reduces power requirements and allows for battery powered wireless communications with acceptable battery life and cost. In some applications, battery power eliminates the need for any external wires to the device beyond the sensor inputs and facilitates the installation.

In an alternative embodiment, the housing incorporating the telemetry unit is connected to an external solar panel. The solar panel is the power source for the telemetry unit. This allows the telemetry device to be employed in a vast variety of remote site applications, especially within the petrochemicals market.

In a particular embodiment, a visible light, such as a light emitting diode, may be used to indicate parameters of the telemetry device to a user. For example, an LED strip may indicate the transmission power remaining based on battery life. Also, push buttons may be provided to allow a user to program the telemetry device. These features allow the customer to test the communications on the device without having to hook up the configuration software tool.

Although a few illustrative embodiments have been described in detail, it should be understood that various changes, substitutions and alterations can be made to these embodiments without departing from their spirit and scope of the present invention. For example, while the embodiment of FIG. 7 shows a wireless network, the communication network may alternatively be implemented with a wireline network. Accordingly, the present invention shall not be limited by the particular illustrative embodiments of the prior disclosure, but shall be defined by the following claims and their equivalents, as interpreted to provide the broadest permissible interpretation allowed by law.

What is claimed:

1. A system comprising:
a remote telemetry device communicatively coupled to at least a portion of a cathodic protection system, the telemetry device programmable to communicate with a central station upon at least one of an alarm condition, a regular time interval, and a user request, the alarm condition comprising any measurement that is outside of a user defined range, the telemetry device incorporating a transmitter and a processor that includes non-volatile memory and programming code to control operation of the telemetry device;
a central station, responsive to the remote telemetry device, the central station including a central station computer server and software embedded therein to provide connection with a wide area network communications module, a database hosting module hosting a central database, and a notification module to issue alarm notification messages, the wide area network communications module to manage message traffic between a wide area communications network and the central database;
a central database to store and organize information communicated by the telemetry device; and
a computer network user interface that provides a user with remote access to the information stored at the central database.

2. The system of claim 1, further comprising a plurality of telemetry devices in communication with the central station.

3. The system of claim 1, wherein the user interface allows the user to view or export data gathered from the telemetry device.

4. The system of claim 1, wherein the user interface allows a user to modify a telemetry device notification method.

5. The system of claim 1, wherein the user interface allows users to remotely request data from the remote telemetry device.

6. The system of claim 1, wherein the user interface allows a user to remotely reprogram the remote telemetry device.

7. The system of claim 6, wherein the remote reprogramming is implemented by sending data message to the remote telemetry device where the data message is decoded at the telemetry device to change a parameter of the telemetry device.

8. The system of claim 1, wherein the user interface allows the user to change the output of the telemetry device remotely.

9. The system of claim 1, where the notification module automatically issues notifications of alarm events via a communication facility.

10. The system of claim 9, wherein the communication facsimile is selected from the group consisting of a numeric pager, an alpha-numeric pager, an electronic mail and a voice message.

11. The system of claim 1, where the user may establish, delete or modify notification methods via the user interface.

12. The system of claim 1, wherein the central database is configured to store information about the telemetry device.

13. The system of claim 12, wherein the stored information about the telemetry device includes at least one of identification information, data gathered from the remote telemetry device, configuration information, notification methods, alarm information, production data, return materials information, shipping information, billing information, and services charges.

14. The system of claim 1, further comprising a software tool to allow a user to configure at least one channel of the sensor input and to set different alarming conditions on each channel.

15. The system of claim 14, wherein the configuration software tool allows a user to configure a reporting frequency for the telemetry device.

16. The system of claim 14, wherein the configuration software tool is used to specify a serial data range to be captured and reported by the telemetry device.

17. The system of claim 1 where the sensor input is selected from the group consisting of temperature, pressure, on/off, open/closed, voltage, amperage, counting, resetting, serial data, sensors that provide digital (contact closure) input, analog input (from −5 to +5V, −50 to +50 mV, 4-2 mA or any other reasonable range of analog input), serial data, level detection, and resistance.

18. The system of claim 1 wherein the communications network employed is a wireless wide area network.

19. The system of claim 1 where the remote telemetry device is battery powered.

20. The system of claim 1 where the remote telemetry device is enclosed in a housing, the housing connected to an external solar panel.

21. The system of claim 20, wherein the solar panel is suitable to operate in hazardous locations.

22. The system of claim 14 where the remote telemetry device has a push button that can be used to prompt a test transmission to the central station, the test transmission independent of using the configuration software tool.

23. The system of claim 1 where the telemetry device includes a visible indicator to inform a user about transmission strength of the transmitter.

24. The system of claim 1 wherein the telemetry device has a visible indicator, including light emitting diodes, to inform a user whether a test transmission to the central station was successfully received by indicating the receipt from the central station of a return confirmation message.

25. The system of claim 1 wherein the remote telemetry device uploads configuration information to a web site in the form of a specially identified data transmission that the central station uses to populate the central database.

26. The system of claim 1 wherein the remote telemetry device has a capability to receive a message sent by the central station and take a preprogrammed action in response to decoding the message.

27. The system of claim 26, wherein the pre-programmed action is one or more of changing a measurement reporting frequency, changing alarm conditions, changing the clock date and time, or changing a state of an output channel.

28. The system of claim 14 wherein the software configuration tool is used to check radio frequency signal strength of the transmitter on the communications network at the remote site location of the remote telemetry device.

29. The system of claim 14 wherein the software configuration tool is used to prompt a test transmission to provide communications between the telemetry device and the central station.

30. The system of claim 14 wherein the software configuration tool is used to prompt the telemetry device to transmit configuration data to the central station.

31. The system of claim 1 wherein the wide area communications network is selected from the group of a wireless cellular control channel network, a plain old telephone service, a satellite data network, a cellular digital packet data network, a two way paging network, and a digital cellular service network.

32. The system of claim 1 wherein the central database is a relational database that allows information to be quickly accessed by individual devices or by groups of devices.

33. The system of claim 1, wherein the portion of the cathodic protection system comprises a rectifier.

34. A system comprising:
a remote telemetry device communicatively coupled to at least one cathodic protection device operable to provide direct current to a metallic object, the telemetry device programmable to communicate with a central station, the telemetry device incorporating a transmitter and a processor;
the processor including memory and programming code to control operation of the telemetry device; and
the transmitter operable to communicate information to a central station.

35. The system of claim 34, further comprising a second remote telemetry device communicatively coupled to a second cathodic protection device operable to provide direct current to a metallic object, the second remote telemetry device further operable to communicate information to the central station.

36. The system of claim 34, further comprising a power source, the power source responsive to an alternating current transmission, the power source connected to the remote telemetry device.

37. The system of claim 36, wherein the power source provides power to both the cathodic protection device and the remote telemetry device.

38. The system of claim 34, wherein the cathodic protection device comprises a rectifier.

39. The system of claim 34 further comprising:
the central station, responsive to the remote telemetry device, the central station including a central station computer server and software embedded therein to provide connection with a wide area network communications module, a database hosting module hosting a central database, and a notification module to issue alarm notification messages, the wide area network communications module to manage message traffic between a wide area communications network and a central database;
the central database to store and organize information communicated by the telemetry device;
a computer network user interface that provides a user with remote access to the information stored at the central database; and
a power source, the power source responsive to an alternating current transmission, the power source connected to the remote telemetry device.

40. The system of claim 39, wherein the power source receives alternating current electrical energy and provides a direct current power source to the remote telemetry device.

41. The system of claim 39, wherein the power source includes a voltage regulator.

42. The system of claim 39, wherein a user can modify configuration parameters of the telemetry device remotely through the computer network user interface via an internet connection.

43. A method of remote monitoring using a computer network, the method comprising:
communicatively coupling a remote telemetry device to at least one cathodic protection device, the cathodic protection device operable to provide direct current to a metallic object in a corrosive environment; and
communicating information generated by the cathodic protection device to a central station with the remote telemetry device upon at least one of an alarm condition, a user request, and a regular time interval.

44. The method of claim 43, further comprising:
storing the information communicated by the telemetry device in a central database; and
providing a user with remote access to the central database.

45. The method of claim 43, further comprising:
determining that the information generated by the cathodic protection device represents an alarm condition;
issuing an alarm notification message in response to the alarm condition.
